(19) United States
(12) Patent Application Publication
(10) Pub. No.: US 2003/0185746 A1
(43) Pub. Date: Oct. 2, 2003

(54) Calcined alumina, its production method and fine alpha-alumina powder obtained by using the calcined alumina

(75) Inventors: Kazuhisa Kajihara, Niihama-shi (JP); Yoshiaki Takeuchi, Niihama-shi (JP)

Correspondence Address: SUGHRUE MION, PLLC, 2100 Pennsylvania Avenue, NW, Washington, DC, 20037-3213, US

(73) Assignee: SUMITOMO CHEMICAL COMPANY, LIMITED

(21) Appl. No.: 10/340,655

(22) Filed: Jan. 13, 2003

(30) Foreign Application Priority Data
Jan. 16, 2002 (JP) 2002-007169

(51) Int. Cl. C01F 7/02

(52) U.S. Cl. 423/625

(57) ABSTRACT

A calcined alumina, its production method and fine a alumina powder obtained by using the calcined alumina are described. The calcined alumina has the SET specific surface area of 10 to 20 m²/g, the main crystal phase of α phase, a θ phase not substantially contained, and the average particle size of 0.5 μm or less. The method for producing the calcined alumina comprising calcining an aluminum-containing substance containing substantially no metal element other than aluminum in an atmosphere having a partial pressure of water vapor of 600 Pa or less. The fine α-alumina powder having a purity of 99.99% or more and a BET specific surface area of 15 m²/g or more, containing substantially no transition alumina, and providing, when calcined at 1250° C. under normal pressure, a sintered body having a relative density of 95% or more.

### FIELD OF THE INVENTION

The present invention relates to a calcined alumina, its production method and fine α-alumina powder obtained from the calcined alumina.

### BACKGROUND OF THE INVENTION

α-alumina powders are widely used as a raw material for production of various ceramics such as sintered bodies and translucent tubes and as an abrasive or the like. This α-alumina powder is obtained by calcining of an aluminum compound such as aluminum hydroxide, transition alumina, ammonium alum, aluminum chloride, ammonium aluminum carbonate in air.

An finer powder of an α-alumina is more excellent in sintering property. When a fine α-alumina powder is used for sintered body, densification can be obtained even if the sintering temperature is low, consequently, the grain size of a sintered body can be maintained small, and a sintered body having high mechanical strength can be obtained. Therefore, finer α-alumina powders are desired.

Conventionally, as the method of obtaining a fine α-alumina powder, there are known the above-mentioned method of calcining an above-mentioned aluminum compound at lower temperature, or a method of adding a silicon compound to an aluminum compound and calcining the mixture.

However, in the method of calcination at lower temperature, a θ phase different from an a phase tends to remain, and it was difficult to obtain an alumina powder composed of a single a phase. In general, if an α-alumina powder containing a θ phase is molded and sintered, a sintered body of high density is sometimes not obtained. Further, if this α-alumina powder is dispersed in water to prepare a slurry, the viscosity of the slurry change with the lapse of time and disadvantages occurs in molding, in some cases. In the method of adding a silicon compound and calcining the mixture, an alumina powder which is finer to a certain extent can be obtained, however, a sintered body obtained by molding and sintering this alumina powder was non-uniform in grain size and could not provide sufficient mechanical strength and corrosion resistance, in some cases.

In these method, even if a fine α-alumina powder is obtained, a sintered body having a uniform grain size cannot be obtained when molding and sintering this powder since other components than α-alumina are contained.

### SUMMARY OF THE INVENTION

An object of the present invention is to provide an calcined alumina having high purity and suitable for producing a fine α-alumina powder and a method for producing the same. Another object of the present invention is to provide a fine α-alumina powder suitable for producing a sintered body having a uniform grain size.

The present inventors have studied a method for producing a fine α-alumina powder, and resultantly found a calcined alumina suitable as a raw material for producing a fine α-alumina powder, leading to completion of the present invention.

Namely, the present invention provides a calcined alumina wherein the BET specific surface area is from 10 to 20 m²/g, the main crystal phase is an a phase, a θ phase is not substantially contained, and the average particle size is 0.5 μm or less.

Also, the present invention provides a method for producing a calcined alumina wherein an aluminum-containing substance containing substantially no metal element other than aluminum is calcined in an atmosphere having a partial pressure of water vapor of 600 Pa or less.

Further, the present invention provides a fine α-alumina powder having a purity of 99.99% or more and a BET specific surface area of 15 m²/g or more, containing substantially no transition alumina, and providing, when calcined at 1250° C. under normal pressure, a calcined body having a relative density of 95% or more.

### BRIEF EXPLANATION OF DRAWINGS

FIG. 1 is an XRD spectrum of transition alumina used in Example 1.

FIG. 2 is an XRD spectrum of a calcined alumina obtained in Example 1.

FIG. 3 is a TEM photography of a fine alumina powder obtained in Example 1.

FIG. 4 is a correlation diagram of the calcination temperature and the BET specific surface area of the resulted calcined alumina when aluminum-containing substance is transition alumina powder of bulk density 0.2 g/cm³ and dew point of calcination atmosphere is −15° C.

FIG. 5 is a correlation diagram of the calcination temperature and the BET specific surface area of the resulted calcined alumina when aluminum-containing substance is transition alumina powder of bulk density is 0.9 g/cm³ and dew point of calcination atmosphere is −15° C., 0° C., or +20° C.

FIG. 6 is a correlation diagram of the calcination temperature and the BET specific surface area of the resulted calcined alumina when aluminum-containing substance is aluminum hydroxide powder and dew point of calcination atmosphere is −15° C.

### DETAILED DESCRIPTION OF PREFERRED EMBODIMENTS

The present invention will be described in detail below. The calcined alumina of the present invention has a BET specific surface area of 10 m²/g or more, preferably 12 m²/g or more, more preferably 13 m²/g or more and 20 m²/g or less, preferably 17 m²/g or less. This calcined alumina has an average particle size of 0.5 μm or less, preferably 0.1 μm or less. The average particle size can be measured by photographing a calcined alumina by a transmission electron microscope and measuring the particle size of particles in the image. Further, in this calcined alumina, the main crystal phase is an α phase, and other phases than an a phase, for example, a θ phase is not substantially contained. “Not substantially contained” means, for example, the intensity of the θ phase is 0.01 or less based on the intensity of α phase in XRD spectrum. The crystal phase of a calcined alumina can be decided from the X ray diffraction (XRD) measured of a composition.

The calcined alumina of the present invention can be obtained, for example, by calcining an aluminum-containing substance in an atmosphere having a partial pressure of water vapor of 600 Pa or less.

As the aluminum-containing substance used here, those containing compound becoming α-alumina by calcination in air of 1000° C. or higher are exemplified, and examples of the compound include transition alumina of which crystal phase is γ, χ, θ, δ, σ or κ, amorphous alumina, aluminum hydroxide of which crystal phase is gibbsite, boehmite, pseudo-boehmite, bayerite, norstrandite or diaspore, amorphous aluminum hydroxide, aluminum oxalate, aluminum acetate, aluminum stearate, ammonium alum, aluminum lactate, aluminum laurate, ammonium aluminum carbonate, aluminum sulfate, ammonium aluminum sulfate, aluminum nitrate or ammonium aluminum nitrate, and the like. These can be used alone or in admixture of two or more. The aluminum-containing substance is preferably those containing transition alumina or aluminum hydroxide as a main component. In this case, the amount of transition alumina or aluminum hydroxide is usually 60% by weight or more, preferably 80% by weight or more, more preferably 95% by weight or more based on the aluminum-containing substance. This aluminum-containing substance contains substantially no metal element other than aluminum, and for example, the element contents of silicon (Si), iron (Fe), titanium (Ti), sodium (Na) and calcium (Ca) are each 50 ppm or less. The total amount of them is preferably 100 ppm or less.

This aluminum-containing substance preferably contains α-alumina or its precursor (diaspore etc.) which is transferred to α-alumina in lower temperature than that of a main component(boehmite, pseudo-boehmite etc.). An aluminum-containing substance containing α-alumina is preferably used since a finer α-alumina powder can be obtained. The content of this α-alumina is usually 1% by weight or more and 20% by weight or less, preferably 10% by weight or less based on the aluminum-containing substance.

A method for producing the aluminum-containing substance to contain α-alumina may include a method of mixing aluminum-containing substance with an α-alumina particle, or a method in which the aluminum-containing substance is pre-calcined and aluminum compound contained in an aluminum-containing substance is partially transferred to α-alumina. In the former method, the α-alumina particle to be mixed preferably has particle size smaller than the particle size of a fine α-alumina powder obtained by calcining an aluminum-containing substance to obtain calcined alumina and grinding the calcined alumina, and preferably has a particle size of 0.1 μm or less.

By the latter method, an aluminum-containing substance may contain small α-alumina. In this case, pre-calcination may be conducted, for example, by maintaining an aluminum-containing substance in air at the temperatures from 800° C. to 1200° C. The content of small α-alumina can be controlled by changing the calcination temperature and time, for example, the α-alumina content may be increased by raising the calcination temperature or elongating the calcination time.

A commercially available product may be used if it is an aluminum-containing substance containing α-alumina in given amount as shown above.

A method for producing the aluminum-containing substance to contain α-alumina's precursor may include a method of mixing aluminum-containing substance with a precursor particle. The content of this precursor is usually 1% by weight or more and 20% by weight or less, preferably 10% by weight or less in terms of aluminum oxide (Al2O3), based on the aluminum-containing substance.

The aluminum-containing substance containing α-alumina or its precursor may be subjected to grinding before calcination, if necessary. α-alumina or its precursor can be uniformly dispersed in an aluminum-containing substance by grinding. The grinding may be conducted by using a vibration mill, ball mill or jet mill and the like. In grinding, it is preferable to decrease pollution by silicon and calcium from a grinding medium, and for this, it is recommended to use alumina having a purity of 99% by weight or more as the material of a grinding medium of a vibration mill or ball mill or of a nozzle and liner in a jet mill.

The aluminum-containing substance used for producing a calcined alumina preferably has lower bulk density, for example, preferably has a bulk density of 0.5 g/cm³ or less, further, 0.3 g/cm³ or less, in terms of aluminum oxide (Al₂O₃). By calcining an aluminum-containing substance having lower bulk density, a calcined alumina suitable for obtaining a finer alumina powder can be produced.

The above-mentioned aluminum-containing substance is calcined. The calcination is conducted in an atmosphere in which the partial pressure of water vapor is controlled, and usually conducted in an atmosphere in which the partial pressure of water vapor is 600 Pa or less (dew point is 0° C. or lower in the case of a gas having a total pressure of 1 atm). The lower partial pressure of water vapor in the calcination atmosphere is preferable, and it is preferably 165 Pa or lower (dew point is −15° C. or lower in the case of a gas having a total pressure of 1 atm), more preferably 40 Pa or lower (dew point is −30° C. or lower in the case of a gas having a total pressure of 1 atm).

The calcination may be conducted by an apparatus by which the atmosphere can be controlled to a partial pressure of water vapor of 600 Pa or lower, for example, can be conducted by discharging a gas out of a furnace or introducing a gas, using a calcination furnace such as tubular type electric furnace, box type electric furnace, tunnel furnace, far infrared furnace, micro wave heating furnace, shaft kiln, reflection kiln, rotary kiln, roller hearth kiln, shuttle kiln, pusher plate kiln, fluidized-bed calcination furnace. In calcination, when an aluminum-containing substance generating little water vapor such as transition alumina is used as a raw material, calcination can be conducted by charging an aluminum-containing substance in a vessel and introducing dry air having a partial pressure of water vapor of 600 Pa or lower before sealing the vessel. Calcination may be conducted under reduced pressure when the atmosphere has a partial pressure of water vapor of 600 Pa or lower, for example, can be conducted under a pressure-reduced atmosphere having a total pressure of 600 Pa or lower composed of a gas such as air, hydrogen, helium, nitrogen and argon. The calcination furnace used in this operation may be batch-wise or continuous. Calcination is conducted at a temperature necessary for phase-changing from an aluminum-containing substance to α-alumina, and the temperature is usually 1000° C. or higher, preferably 1100° C. or higher, and 1250° C. or lower, preferably 1200° C. or lower. The calcination time differs depending on the kind of a calcination furnace used and the calcination temperature, and usually 10 minutes or longer, preferably 30 minutes or longer, and 12 hours or less.

As the gas introduced into a furnace, those having controlled a partial pressure of water vapor are preferably used, and for example, there are preferably used dry air obtained by compressing air by a compressor to condense moisture contained in air, separating this condensed moisture, then, reducing the pressure, dry air obtained by removing moisture from air by a dehumidifier, dry nitrogen obtained by evaporating liquid nitrogen, and the like. A commercially available cylinder filled with air, helium, nitrogen and the like can be used providing no moisture is contained.

An alumina powder obtained by calcination may be subjected to particle size control such as grinding, classification and the like, if necessary. Grinding can be conducted by using a vibration mill, ball mill, jet mill and the like, and classification can be conducted by using a sieve and the like.

The calcined alumina of the present invention thus obtained is easily ground to give fine particles. By grinding this calcined alumina, a fine alumina powder for application to a sintered body or abrasive can be obtained easily. A fine alumina powder obtained by grinding usually has a purity of 99.99% or more, a BET specific surface area of 15 m²/g or more, and a crystal phase which is substantially an a phase containing no θ phase. This sintered body having a relative density of 95% or more is obtained by using this fine alumina powder as raw material when it is molded by a mono-axial press under a molding pressure of 30 MPa, then, molded by a cold isostatic pressing (CIP) at a molding pressure of 100 MPa, and this molded body is sintered under normal pressure for 2 hours in air of 1250° C. This fine alumina powder usually has contents of Si, Fe, Ti, Na andCa of each 50 ppm or less in terms of metal elements, and a total content of them of 100 ppm or less. Those having further reduced content of these elements can also be obtained by selection of the material of a calcination furnace, selection of the material of a grinding medium used in grinding optionally conducted, and the like.

### EXAMPLES

The present invention is described in more detail by following Examples, which should not be construed as a limitation upon the scope of the present invention. The BET specific surface area, crystal phase and contents of Si, Fe, Ti, Na and Ca were determined by the following methods.

BET specific surface area (m²/g): It was determined by a nitrogen adsorption method.

Crystal phase: A sample was analyzed by an X-ray diffractometer (trade name: Rint-200, manufactured by Rigaku Denki K.K.), the crystal phases were identified by the peak data of the resulted XRD spectrum, and a phase showing the highest relative peak intensity is used as the main crystal phase.

Contents of Si, Fe, Ti, Na and Ca (ppm): These were determined by emission spectrochemical analysis.

### Example 1

[Preparation of Transition Alumina Powder]

Aluminum hydroxide obtained by hydrolyzing aluminum isopropoxide was pre-calcined to obtain transition alumina of which main crystal phase is a θ phase and containing α-alumina in an amount of 3% by weight. Regarding the α-alumina content in transition alumina, transition alumina was analyzed by an X-ray diffractometer, the resulted XRD spectrum was compared with a standard spectrum obtained by adding a given amount of α-alumina to transition alumina, to calculate the α-alumina content. The above-mentioned transition alumina was ground by using a jet mill, to obtain transition alumina having a bulk density of 0.21 g/cm³.

[Production of Calcined Alumina]

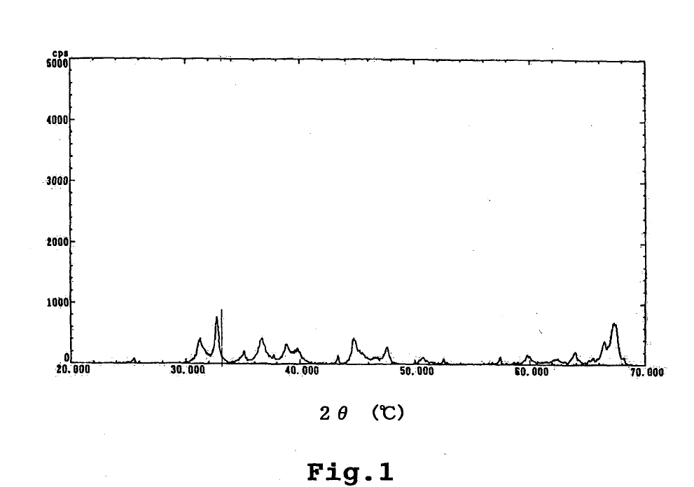

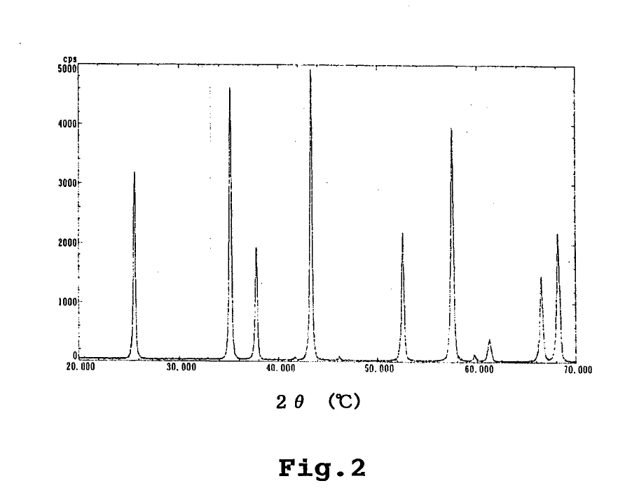

100 g of this transition alumina powder was charged into a tubular type electric furnace having a volume of 8 Liter (manufactured by Motoyama K.K.), dry air having a dew point of −15° C. (partial pressure of water vapor: 165 Pa) was introduced into the furnace at a rate of 1 L/min., the powder was heated up to 1170° C. and this temperature was maintained for 3 hours while maintaining the dew point of the atmosphere in the furnace at −15° C., then, the powder was gradually cooled. A calcined alumina was obtained by calcination under the above-mentioned conditions. This calcined alumina had a BET specific surface area of 13 m²/g, had a main crystal phase which was an a phase and containing no θ phase, and had an average particle size of 0.1 μm. The X-ray diffraction (XRD) spectrum of the transition alumina obtained here is shown in FIG. 1, and the XRD spectrum of the resulted calcined alumina is shown in FIG. 2. Regarding the presence or absence of a θ phase in the calcined alumina, the calcined alumina was analyzed by an X-ray diffractometer, the peak intensity Z of a θ phase (diffraction angle: 32.7°) and the peak intensity W of an a phase (diffraction angle: 57.5°) were measured from the resulted XRD spectrum, and when the ratio Z/W was more than 0.01, it was decided that a θ phase was present.

[Production of Fine Alumina Powder]

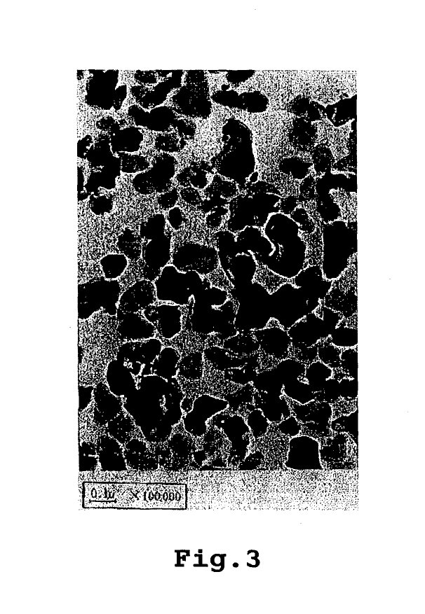

This calcined alumina was ground by using a vibration mill (grinding medium: made of alumina), to obtain a fine alumina powder. This fine alumina powder had a BET specific surface area of 16 m²/g, a Si content of 19 ppm, a Fe content of 8 ppm, a Ti content of 1 ppm or less, Na content of 8 ppm and a Ca content of 3 ppm, and a purity of 99.996%. The TEM photography of this powder is shown in FIG. 3. This powder was molded by amono-axial press under a molding pressure of 30 MPa, then, molded by a cold isostatic pressing (CIP) at a molding pressure of 100 MPa, and this molded body was sintered under normal pressure for 2 hours in air of 1250° C. The resulted sintered body had a relative density of 97%.

When the above-mentioned fine alumina powder is used, ceramics excellent in mechanical strength and corrosion resistance can be obtained. Further, when this fine alumina powder is used as an abrasive grain, an abrasive can be obtained at high abrasion speed causing no abrasion flaw.

### Example 2

An α-alumina powder having an average particle size of 0.1 μm was added to aluminum isopropoxide, then, the mixture was hydrolyzed, to obtain aluminum hydroxide of which main crystal phase is a pseudo-boehmite and containing α-alumina in an amount of 1% by weight.

100 g of the resulted aluminum hydroxide was calcined under the same conditions as in Example 1 [Production of calcined alumina], to obtain a calcined alumina. This calcined alumina had a BET specific surface area of 14 m²/g, had a main crystal phase which was an a phase and containing no θ phase, and had an average particle size of 0.1 μm.

### Example 3

A calcined alumina was obtained in the same operation as in Example 1 excepting that the dew point of air introduced into the furnace was changed to 0° C. (partial pressure of water vapor: 600 Pa) in calcination. This calcined alumina had a BET specific surface area of 11 m²/g, had a main crystal phase which was an α phase and containing no θ phase, and had an average particle size of 0.1 μm.

### Comparative Example 1

A calcined alumina was obtained in the same operation as in Example 1 excepting that the dew point of air introduced into the furnace was changed to 20° C. (partial pressure of water vapor: 2300 Pa) in calcination. This calcined alumina had a BET specific surface area of 9 m²/g, and had a main crystal phase which was an a phase and containing no θ phase.

This calcined alumina was subjected to the same operation as in Example 1 [Production of fine alumina powder], to obtain an alumina powder. This alumina powder had a BET specific surface area of 11 m²/g. This powder was molded by a mono-axial press under a molding pressure of 30 MPa, then, molded by a cold isostatic pressing (CIP) at a molding pressure of 100 MPa, and this molded body was sintered under normal pressure for 2 hours in air of 1250° C. The resulted sintered body had a relative density of 90%.

### Comparative Example 2

An alumina powder was obtained in the same operation as in Comparative Example 1 excepting that the calcination temperature was changed to 1150° C. This alumina powder had a BET specific surface area of 10 m²/g, and had a main crystal phase which was an a phase and containing a θ phase.

### Test Example 1

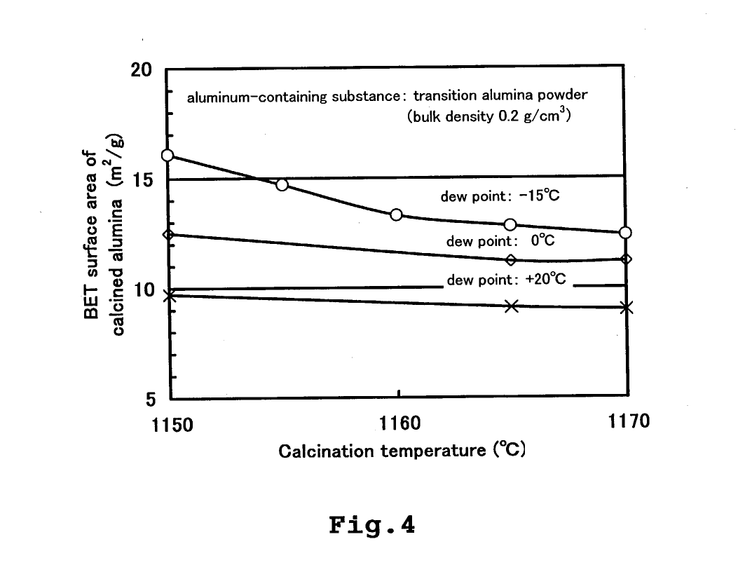

A calcined alumina was obtained in the same operation as in Example 1 [Production of fine alumina powder] excepting that a transition alumina powder having a bulk density of 0.2 g/cm³ was used and the dew point of the atmosphere in the furnace and the calcination temperature were changed. The correlation between the calcination temperature at each dew point and the BET specific surface area of the resulted calcined alumina is shown FIG. 4.

### Test Example 2

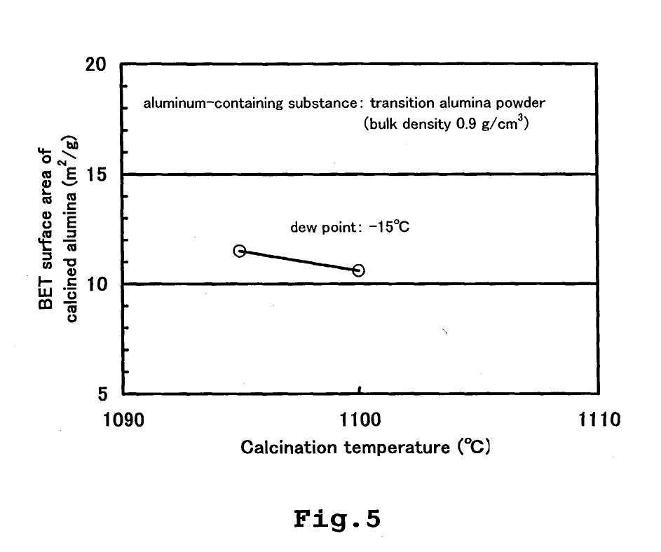

A calcined alumina was obtained in the same operation as in Example 1 [Production of fine alumina powder] excepting that a transition alumina powder having a bulk density of 0.9 g/cm³ was used and the calcination temperature was changed. The correlation between the calcination temperature and the BET specific surface area of the resulted calcined alumina is shown FIG. 5.

### Test Example 3

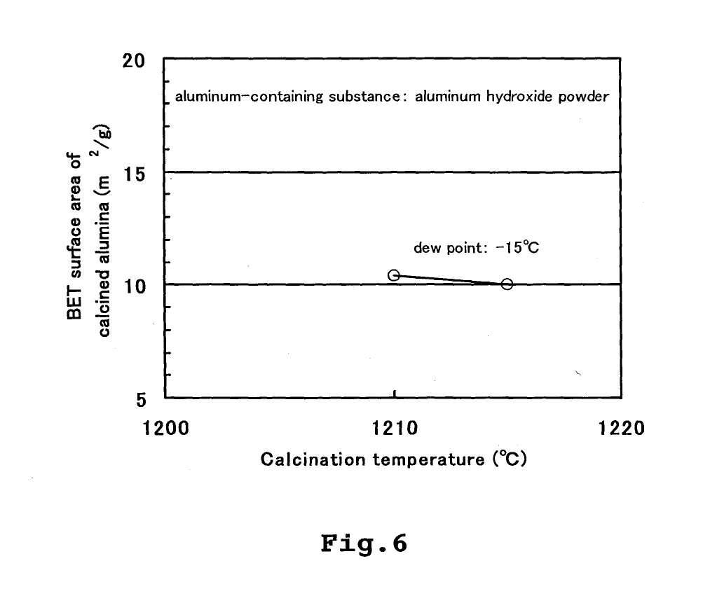

A calcined alumina was obtained in the same operation as in Example 1 [Production of fine alumina powder] excepting that an aluminum hydroxide powder was used and the calcination temperature was changed. The correlation between the calcination temperature and the BET specific surface area of the resulted calcined alumina is shown FIG. 6.

The calcined alumina of the present invention is suitable as a raw material for production of a fine α-alumina powder. According to the method for producing a calcined alumina of the present invention, the above-mentioned calcined alumina can be obtained easily. Further, with the fine α-alumina powder of the present invention, ceramics excellent in mechanical strength and corrosion resistance can be obtained.

What is claimed is:

1. A calcined alumina having the BET specific surface area of 10 to 20 m²/g, the main crystal phase of α phase, a θ phase not substantially contained, and the average particle size of 0.5 μm or less.

2. The calcined alumina according to claim 1, wherein the BET specific surface area is from 12 to 17 m²/g.

3. The calcined alumina according to claim 1, wherein the average particle size is 0.1 μm or less.

4. A method for producing a calcined alumina comprising calcining an aluminum-containing substance containing substantially no metal element other than aluminum in an atmosphere having a partial pressure of water vapor of 600 Pa or less.

5. The method according to claim 4, wherein the aluminum-containing substance contains α-alumina or its precursor.

6. The method according to claim 4, wherein the aluminum-containing substance has a bulk density of 0.5 g/cm³ or less in terms of aluminum oxide.

7. The method according to claim 4, wherein the aluminum-containing substance has a bulk density of 0.3 g/cm³ or less in terms of aluminum oxide

8. The method according to claims 4, wherein the main component of the aluminum-containing substance is transition alumina or aluminum hydroxide.

9. The method according to claims 4, wherein calcination is conducted at temperatures of from 1000° C. to 1250° C.

10. The method according to claims 4, wherein calcination is conducted at temperatures of from 1100° C. to 1200° C.

11. The method according to claim 4, wherein the partial pressure of water vapor is 165 Pa or less.

12. The method according to claim 4, wherein the partial pressure of water vapor is 40 Pa or less.

13. The method according to claim 4, wherein the aluminum-containing substance is pre-calcined to produce aluminum-containing substance containing α-alumina before calcination.

14. The method according to claim 4, wherein the aluminum-containing substance and α-alumina particles are mixed to produce aluminum-containing substance containing α-alumina before calcination.

15. A fine α-alumina powder having a purity of 99.99% or more and a BET specific surface area of 15 m²/g or more, containing substantially no transition alumina, and providing, when calcined at 1250° C. under normal pressure, a sintered body having a relative density of 95% or more.
